(19) United States
(12) Patent Application Publication
(10) Pub. No.: US 2024/0257581 A1
(43) Pub. Date: Aug. 1, 2024

(54) INFORMATION PROCESSING DEVICE

(71) Applicant: TOYOTA JIDOSHA KABUSHIKI KAISHA, Toyota-shi (JP)

(72) Inventors: Yohsuke HASHIMOTO, Nagacute-shi (JP); Satoshi AKIMA, Nagakute-shi (JP)

(73) Assignee: TOYOTA JIDOSHA KABUSHIKI KAISHA, Toyota-shi (JP)

(21) Appl. No.: 18/545,045

(22) Filed: Dec. 19, 2023

(30) Foreign Application Priority Data
Jan. 26, 2023 (JP) 2023-010534

(51) Int. Cl. G07C 5/00; G07C 5/08; G08G 1/16

(52) U.S. Cl. CPC G07C 5/008; G07C 5/0808; G08G 1/168

(57) ABSTRACT

A control unit of an information processing device acquires a first frequency that is a frequency of forward parking events of a first vehicle per unit period. When the first frequency is equal to or greater than a first threshold, the control unit of the information processing device sends first information on first equipment to a first terminal associated with a user of the first vehicle. The first equipment is equipment that assists in a driving operation for driving out the forward parked first vehicle in reverse and that is mountable on the first vehicle.

### CROSS-REFERENCE TO RELATED APPLICATION

This application claims priority to Japanese Patent Application No. 2023-010534 filed on Jan. 26, 2023, incorporated herein by reference in its entirety.

### BACKGROUND

### 1. Technical Field

The present disclosure relates to information processing devices.

### 2. Description of Related Art

There is known a technique of detecting moving objects approaching from the right or left of a vehicle and notifying a driver of the vehicle when the vehicle is reversing out of a parking lot etc. (e.g., U.S. Unexamined Patent Application Publication No. 2010/0271237).

### SUMMARY

It is an object of the present disclosure to provide an effective technique for improving the safety of a user who drives a vehicle.

One aspect of the present disclosure is an information processing device. The information processing device in that case includes, for example, a control unit configured to acquire a first frequency, the first frequency being a frequency of forward parking events of a first vehicle per unit period, and when the first frequency is equal to or greater than a first threshold, send first information on first equipment to a first terminal. The first equipment is equipment that is configured to assist in a driving operation related to reversing and that is mountable on the first vehicle.

The present disclosure can also be regarded as an information processing method in which a computer performs a process of the above information processing device. The present disclosure can also be regarded as a program that causes a computer to perform the above information processing method, or a storage medium storing the program in a non-transitory manner.

According to the present disclosure, it is possible to provide an effective technique for improving the safety of a user who drives a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a schematic configuration of a system according to an embodiment;

FIG. 2 is a diagram showing a hardware configuration example of each of a first vehicle, a user terminal, and a server included in the system according to the embodiment;

FIG. 3 is a block diagram showing an example of functional configurations of an ECU, a user terminal, and a server according to the embodiment;

FIG. 4 is a diagram showing an example of information stored in a vehicle information DB according to this embodiment; and

FIG. 5 is a flowchart illustrating an example of a processing routine executed by the server according to the embodiment;

### DETAILED DESCRIPTION OF EMBODIMENTS

Conventionally, there is known a technique of diagnosing driving of a user of a vehicle and notifying the user of the diagnostic results. The user notified of such diagnostic results can objectively grasp the tendency of his or her driving operation.

Whether there is a tendency to park forward can be considered as one of the items for driving diagnosis. Forward parking is a parking method in which a vehicle is moved forward to enter and park in a parking position. When driving out a forward parked vehicle, it is necessary to reverse (back up) the vehicle from the parking position. Therefore, there is a need for measures to ensure safety for a user who tends to park forward when driving out the vehicle.

Therefore, in the information processing device that is one aspect of the present disclosure, the control unit acquires the first frequency that is the frequency of forward parking events of the first vehicle per unit period. The “first frequency” as used herein refers to, for example, the frequency of forward parking events per operating day. An “operating day” is a day the first vehicle was driven. The frequency of forward parking events per operating day may be, for example, the total number of times the first vehicle was parked forward in a first number of operating days divided by the first number of operating days. The first number of operating days is, for example, the number of days that can ensure accuracy in determining whether there is a tendency to park forward, and is, for example, about 5 to 30 days.

A control unit of an information processing device according to the present disclosure sends first information to a first terminal when the first frequency is equal to or greater than a first threshold. The first information is information for recommending the first equipment. The first equipment is equipment for assisting in a driving operation related to reversing and that is mountable on the first vehicle. The first equipment is a Rear Cross Traffic Alert (RCTA) that detects moving objects approaching from right or left and gives an alert when the first vehicle is reversing. In addition, the first terminal may be a terminal used by the user of the first vehicle (for example, a smartphone, etc.), or a terminal mounted on the first vehicle (for example, a display audio, a car navigation system, etc.)

According to the information processing device of the present disclosure, it is possible to propose equipment (first equipment) suitable for assisting in a driving operation for reversing the first vehicle to a user who tends to park forward.

Hereinafter, embodiments of the present disclosure will be described with reference to the drawings. The configurations of the following embodiments are illustrative, and the present disclosure is not limited to the configurations of the embodiments. Further, the following embodiments can be combined as much as possible.

### Embodiment

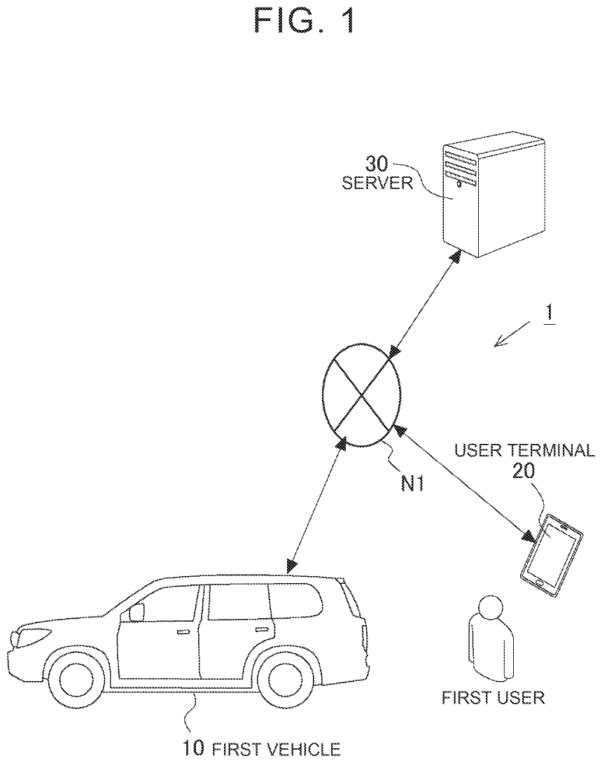

FIG. 1 is a diagram showing a schematic configuration of a system 1 according to the present embodiment. The system 1 is a system for providing a service of diagnosing a driving operation of the first vehicle 10 by the first user and providing the diagnostic results to the first user (hereinafter also referred to as “driving diagnosis service”).

In the example of FIG. 1, system 1 includes first vehicle 10, user terminal 20 and server 30. A first vehicle 10 is a vehicle driven by a first user. The user terminal 20 is a terminal used by the first user. The server 30 performs driving diagnosis for the first vehicle 10 and provides the diagnostic results to the user terminal 20. In this embodiment, the server 30 performs driving diagnosis as to whether the first user tends to park forward. When it is diagnosed in such driving diagnosis that the first user tends to park forward, the server 30 provides the first information in addition to the diagnostic results to the user terminal 20. The first information is information on equipment (first equipment) that assists in a driving operation when driving out the first vehicle 10 in reverse and that is mountable on the first vehicle 10. The user terminal 20 presents the diagnostic results (and the first information) provided form the server 30 to the first user.

The first vehicle 10, the user terminal 20 and the server 30 are interconnected by a network N1. The network N1 is, for example, a Wide Area Network (WAN), which is a worldwide public communication network such as the Internet, or another communication network. The network N1 may include a telephone communication network such as a mobile phone and/or a wireless communication network such as Wi-Fi (registered trademark). Note that the first vehicle 10 may be connected to the user terminal 20 via short-range wireless communication. Although one first vehicle 10 is illustrated in FIG. 1 as an example, a plurality of first vehicles 10 may exist. Also, a plurality of user terminals 20 may exist according to the number of first vehicles 10.

### System Hardware Configuration

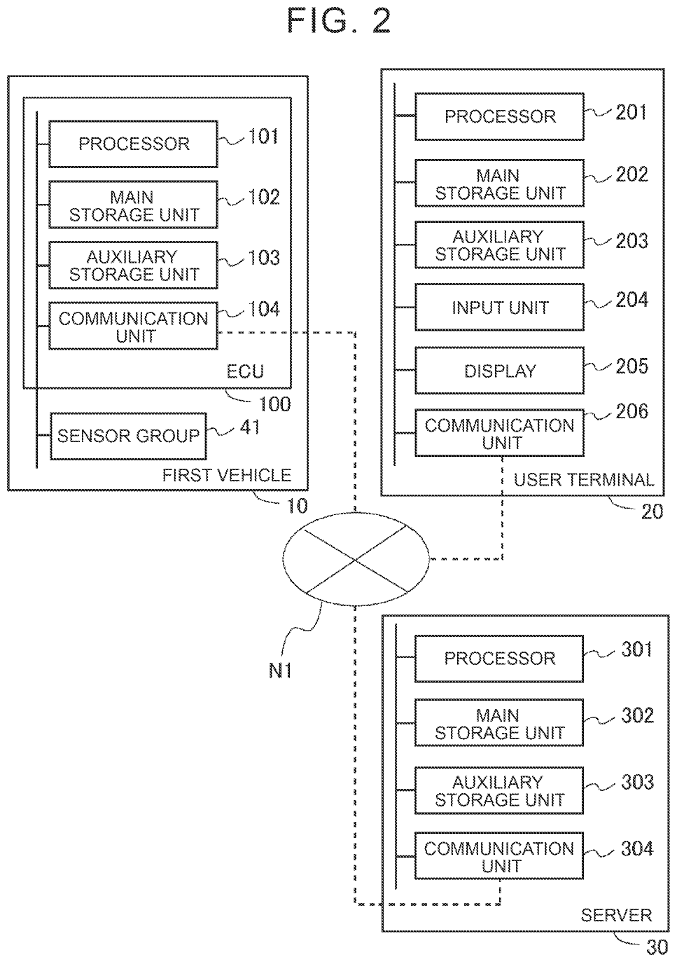

FIG. 2 is a diagram showing an example of the hardware configuration of each of the first vehicle 10, the user terminal 20, and the server 30. In the example shown in FIG. 2, only the hardware configuration related to the driving diagnosis service is extracted and illustrated, but each of the first vehicle 10, the user terminal 20, and the server 30 may may include other hardware configuration.

The first vehicle 10 has an ECU 100 and a sensor group 41. These components are interconnected by an in-vehicle network based on standards such as Controller Area Network (CAN), Local Interconnect Network (LIN), or FlexRay. Note that each of these components may be realized by a combination of an in-vehicle device such as a car navigation system or an in-vehicle communication device instead of a single module.

The ECU 100 is a computer mounted on the first vehicle 10. The ECU 100 includes a processor 101, a main storage unit 102, an auxiliary storage unit 103, and a communication unit 104. The components are connected to each other by a bus.

The processor 101 is a Central Processing Unit (CPU), a Digital Signal Processor (DSP), or the like. The processor 101 controls the ECU 100 and performs various information processing operations. The main storage unit 102 includes a random access memory (RAM), a read only memory (ROM), and the like. The auxiliary storage unit 103 includes an Erasable Programmable ROM (EPROM), Hard Disk Drive (HDD), removable media, or the like. The auxiliary storage unit 103 stores an operating system (OS), various programs, various tables, and the like. The processor 101 loads the program stored in the auxiliary storage unit 103 into the work area of the main storage unit 102 and executes it, thereby controlling each component. As a result, the ECU 100 realizes a function that meets a predetermined purpose. The main storage unit 102 and the auxiliary storage unit 103 are computer-readable recording media. Note that part of the information stored in the auxiliary storage unit 103 may be stored in the main storage unit 102. Further, part of the information stored in the main storage unit 102 may be stored in the auxiliary storage unit 103.

The communication unit 104 is an interface for connecting the ECU 100 to the network N1. The communication unit 104 is a mobile communication service (for example, a telephone communication network such as 6th Generation (6G), 5th Generation (5G), 4th Generation (4G), 3rd Generation (3G), or Long Term Evolution (LTE)), Wi-Fi (registered trademark), or a wireless communication network such as Bluetooth (registered trademark) to communicate with other devices (e.g., server 30, etc.) via network N1.

The sensor group 41 includes, for example, sensors that detect the state of the first vehicle 10 and sensors that detect the actions of the driver. The sensor group 41 includes, for example, a speed sensor, an acceleration sensor, an accelerator operation amount sensor, a steering angle sensor, a yaw rate sensor, a turn signal switch sensor (a sensor that detects the switch state of a direction indicator), a shift position sensor, and a position information sensor. (GPS sensor), brake switch, ultrasonic sensor, radar sensor, camera, and the like.

Next, the user terminal 20 is a computer used by the first user. The user terminal 20 is, for example, a smart phone, a mobile phone, a tablet terminal, a personal information terminal, a wearable computer (such as a smart watch), or a personal computer (PC). The user terminal 20 has a processor 201, a main storage unit 202, an auxiliary storage unit 203, an input unit 204, a display 205, and a communication unit 206. The components are connected to each other by a bus. Since the processor 201, the main storage unit 202, the auxiliary storage unit 203, and the communication unit 206 are the same as the processor 101, the main storage unit 102, the auxiliary storage unit 103, and the communication unit 104 of the ECU 100, the description thereof is omitted. Omitted.

The input unit 204 is a device that receives input operations performed by the first user, and includes, for example, a touch panel, a mouse, a keyboard, a microphone, or push buttons. A display 205 is a device that presents information to the first user, such as a Liquid Crystal Display (LCD) or an Electro luminescence (EL) panel. Note that the input unit 204 and the display 205 may be configured as one touch panel display.

Next, the server 30 is a computer operated by a driving diagnosis service provider. The server 30 has a processor 301, a main storage unit 302, an auxiliary storage unit 303, and a communication unit 304, as shown in FIG. 2. The components are connected to each other by a bus. The processor 301, the main storage unit 302 and the auxiliary storage unit 303 are the same as the processor 101, the main storage unit 102 and the auxiliary storage unit 103 of the ECU 100, so the description thereof will be omitted.

The communication unit 304 of the server 30 is an interface for connecting the server 30 to the network N1. The communication unit 304 includes, for example, a Local Area Network (LAN) interface board or a wireless communication circuit for wireless communication. In this embodiment, the communication unit 304 communicates with the first vehicle 10 and the user terminal 20 through the network N1.

### Functional Configuration of System

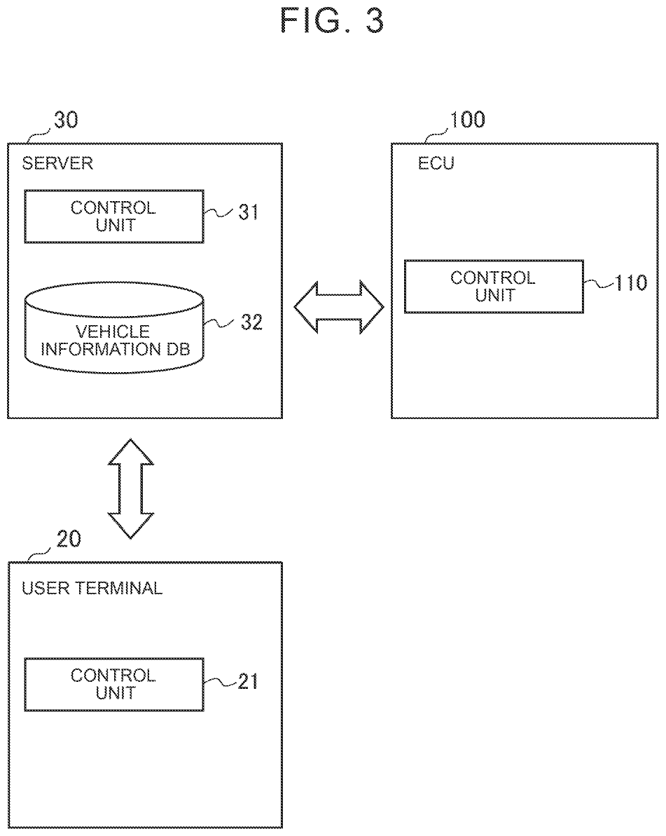

A functional configuration of the system 1 according to this embodiment will be described. FIG. 3 is a block diagram showing an example of functional configurations of each of the ECU 100, the user terminal 20, and the server 30. The functional configurations of the ECU 100, the user terminal 20, and the server 30 are not limited to the configurations illustrated in FIG. 3, and functional components can be omitted, changed, or added as appropriate.

As shown in FIG. 3, the ECU 100 includes a control unit 110 as its functional component. Control unit 110 is achieved by processor 101 of ECU 100 executing a program stored in auxiliary storage unit 103. Note that the control unit 110 may be achieved by a hardware circuit such as an Application Specific Integrated Circuit (ASIC) or a Field Programmable Gate Array (FPGA).

The control unit 110 of the ECU 100 in this embodiment transmits travel information to the server 30 through the communication unit 104 each time the first vehicle 10 finishes traveling for one trip. The travel information is information including, for example, each detection value of the sensor group 41 during the trip, trip date and time (trip start date and time and trip end date and time), information (vehicle ID) for identifying the first vehicle 10, and the like. Note that the travel information may include all detection values of the sensor group 41. The driving information may include only detection values necessary for determining the orientation when the first vehicle 10 is parked. The detection value necessary for determining the direction when the first vehicle 10 is parked may be, for example, data captured by a camera. Further, the “trip” here is a period from when the first vehicle 10 is operated (for example, the ignition switch is turned on) to when it is turned off (for example, the ignition switch is turned off).

The user terminal 20, as shown in FIG. 3, has a control unit 21 as its functional component. The control unit 21 is achieved by executing a program stored in the auxiliary storage unit 203 by the processor 201 of the user terminal 20. Note that the control unit 21 may be achieved by a hardware circuit such as an Application Specific Integrated Circuit (ASIC) or a Field Programmable Gate Array (FPGA).

The control unit 21 of the user terminal 20 in this embodiment presents the diagnostic results (and the first information) provided from the server 30 to the first user. Specifically, when the communication unit 206 of the user terminal 20 receives the diagnostic results (and the first information) sent from the server 30, the control unit 21 displays the diagnostic results (and the first information) on the display 205 of the user terminal 20.

Next, the functional configuration of the server 30 will be described. As shown in FIG. 3, the server 30 in this embodiment has a control unit 31 and a vehicle information DB 32 as its functional components.

Control unit 31 is achieved by processor 301 of server 30 executing a program stored in auxiliary storage unit 303. Note that the control unit 31 may be achieved by a hardware circuit such as an Application Specific Integrated Circuit (ASIC) or a Field Programmable Gate Array (FPGA).

The control unit 31 receives, through the communication unit 304, the travel information transmitted from the ECU 100 each time the first vehicle 10 finishes traveling for one trip. The travel information includes each detection value of the sensor group 41 during the trip, the date and time of the trip, the vehicle ID of the first vehicle 10, and the like, as described above.

Each time the control unit 31 receives travel information sent from the ECU 100, the control unit 31 acquires the date of the trip (date of the operating day) and the number of forward parking events during the trip. The control unit 31 may determine the number of forward parking events by, for example, performing image recognition processing on image data captured by a camera that includes travel information. It should be noted that the method of determining the direction when the first vehicle 10 is parked is not limited to the method of using the imaging data of the camera. For example, when the first vehicle 10 is parked, if an object such as a wall exists in front of the first vehicle 10 and an object such as a wall does not exist behind the first vehicle 10, It may be determined that the first vehicle 10 is parked forward. At that time, whether an object exists in front of or behind the first vehicle 10 may be determined based on a detection value of an ultrasonic sensor, a radar sensor, or the like mounted on the first vehicle 10. When the control unit 31 acquires the date of the trip and the number of forward parking events during the trip, the control unit 31 registers the information in the vehicle information DB 32, which will be described later.

The control unit 31 performs driving diagnosis every time the number of operating days of the first vehicle 10 reaches the first number of operating days, and sends the diagnostic results to the user terminal 20. The first number of operating days is the number of days that can ensure accuracy when determining whether there is a tendency to park forward, and is, for example, about 5 to 30 days. In the driving diagnosis according to the present embodiment, the control unit 31 calculates the first frequency based on information registered in the vehicle information DB 32. Specifically, the control unit 31 calculates the sum (total number) of forward parking events in all trips corresponding to the range of the first operating days. The control unit 31 calculates the number of forward parking events (first frequency) per operating day by dividing the above total number of forward parking events by the first number of operating days.

The control unit 31 executes driving diagnosis based on the calculated first frequency. In the present embodiment, the control unit 31 determines whether the first frequency is equal to or greater than the first threshold. The first threshold is a value at which it can be determined that the first user tends to park forward if the first frequency is equal to or greater than the first threshold. When the first frequency is equal to or greater than the first threshold, the control unit 31 determines that the first user tends to park forward. On the other hand, when the first frequency is less than the first threshold, the control unit 31 determines that the first user does not tend to park forward.

After completing the driving diagnosis based on the first frequency, the control unit 31 sends the diagnostic results to the user terminal 20. When the first frequency is equal to or greater than the first threshold (when it is diagnosed that the first user tends to park forward), the control unit 31 sends the first Information in addition to the diagnostic results to the user terminal 20. The first information is information for recommending the first equipment. The first equipment is equipment that assists in a driving operation for reversing the vehicle and that is mountable on the first vehicle 10. An example of the first equipment is RCTA that detects moving objects approaching from right or left and gives an alert when the vehicle is reversing. The first information is, for example, information on the function of the first equipment (for example, text information or video explaining the function of the first equipment), and information on how to purchase the first equipment (for example, the 1 equipment sales site Uniform Resource Locator (URL), etc.).

Next, the vehicle information DB 32 of the server 30 will be explained. The vehicle information DB 32 is a database constructed in the auxiliary storage unit 303 of the server 30 by the processor 301 of the server 30 executing a database management system (DBMS) program. Vehicle information DB 32 may be constructed as a relational database.

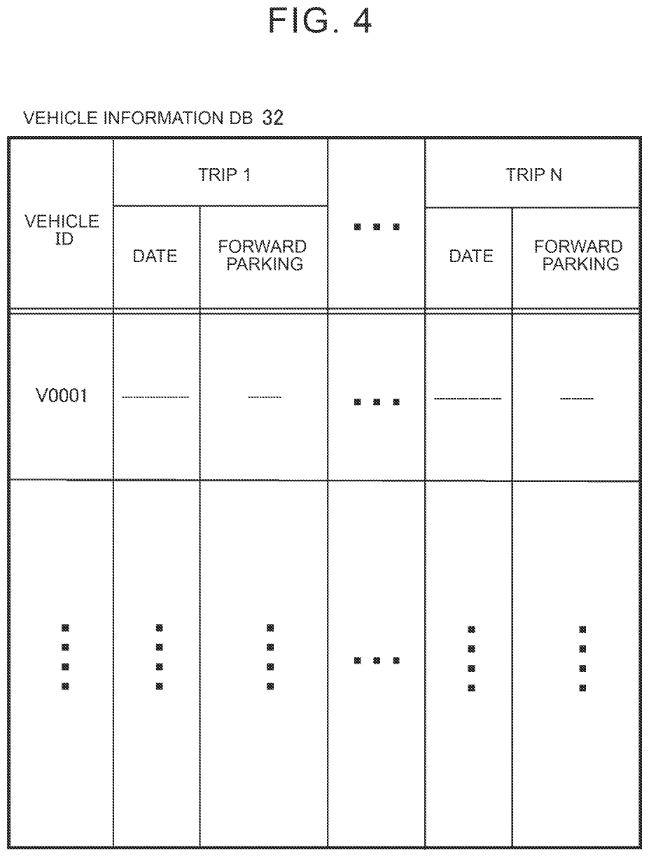

The vehicle information DB 32 in this embodiment stores information on the date of each trip and the number of forward parking events for each vehicle. FIG. 4 is a diagram showing an example of information stored in the vehicle information DB 32 in this embodiment. As shown in FIG. 4, the vehicle information DB 32 in this embodiment has records for each vehicle (hereinafter sometimes referred to as “vehicle information records”). Each vehicle information record has a vehicle ID field and a plurality of (N in FIG. 4) trip fields, as shown in FIG. 4.

In the vehicle ID field of the vehicle information record, information (vehicle ID) for identifying each of the plurality of first vehicles 10 targeted for the driving diagnosis service is registered. Each trip field is divided into subfields, a date field and a forward parking field. The date of each trip is registered in the date field. The forward parking field registers the number of forward parking events in each trip. Information in the date field and forward parking field of each trip field is registered by the control unit 31 each time the server 30 receives travel information transmitted from the ECU 100, as described above.

Note that in the present embodiment, the server 30 corresponds to the “information processing device” according to the present disclosure. The processor 301 of the server 30 corresponds to the “control unit” according to the present disclosure. Also, the user terminal 20 in this embodiment corresponds to the “first terminal” according to the present disclosure.

### Processing Flow

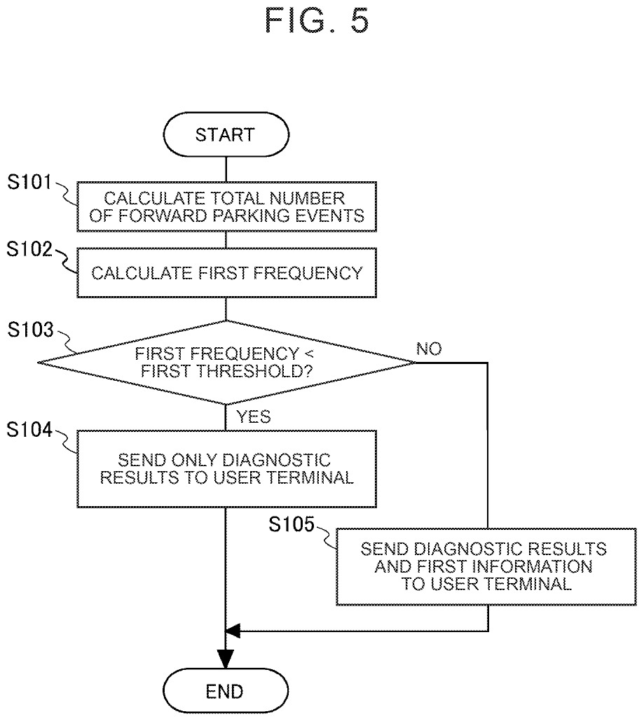

Next, the flow of processing executed by the server 30 will be described with reference to FIG. 5. FIG. 5 is a flowchart showing a processing routine executed by the server 30 each time the number of operating days of the first vehicle 10 reaches the first number of operating days. Although the execution subject of the processing routine shown in FIG. 5 is the processor 301 of the server 30, the functional component (control unit 31) of the server 30 will be described here as the execution subject.

In FIG. 5, the control unit 31 of the server 30 calculates the sum (total number) of forward parking events in all the trips corresponding to the range of the first number of operating days (S101). Specifically, the control unit 31 accesses the vehicle information DB 32 and identifies a vehicle information record in which information matching the vehicle ID of the first vehicle 10 is registered in the vehicle ID field. The control unit 31 extracts, from among the plurality of trip fields registered in the specified vehicle information record, the trip fields whose dates registered in the date fields fall within the range of the first number of operating days. The control unit 31 calculates the total number of forward parking events by obtaining the total number of forward parking events registered in the forward parking field of all the extracted trip fields. After finishing executing the process of S101, the control unit 31 executes the process of S102.

In S102, the control unit 31 calculates the first frequency by dividing the total number of forward parking events calculated in S102 by the first number of operating days. After finishing executing the process of S102, the control unit 31 executes the process of S103.

In S103, the control unit 31 determines whether the first frequency calculated in S102 is less than the first threshold. When the first frequency is less than the first threshold (affirmative determination in S103), the control unit 31 executes the process of S104.

In S104, the control unit 31 sends the diagnostic results of the driving diagnosis (diagnostic results that the first user does not tend to park forward) to the user terminal 20 through the communication unit 304.

When No in S103 (when the first frequency is equal to or greater than the first threshold), the control unit 31 proceeds to S105, and sends the diagnostic results of the driving diagnosis (the first user tends to park forward) and the first information to the user terminal 20 through the communication unit 304. The first information includes, as described above, information on RCTA functions, information on how to purchase RCTA, and the like.

After completing the processing of S104 or S105, the control unit 31 ends the execution of this processing routine.

### Actions and Effects of Embodiment

In the present embodiment, when it is diagnosed that the first user tends to park forward, first information together with the diagnostic results is sent from the server 30 to the user terminal 20. In that case, the user terminal 20 presents the diagnostic results and the first information to the first user through the display 205. As a result, the first user can grasp the diagnostic results and can also recognize the presence of equipment (first equipment) suitable for assisting in a driving operation when driving out the forward parked first vehicle 10 (reversing the first vehicle 10 from the parking position). As a result, it is possible to encourage the user who tends to park forward to install the first equipment.

Therefore, according to the present embodiment, it is possible to contribute to improvement in safety when a user who tends to park forward drives out the first vehicle 10 in reverse.

### MODIFIED EXAMPLES

The above embodiment illustrates an example in which the first frequency is the number of forward parking events per operating day in the first number of operating days. However, the first frequency may be the percentage of the total number of forward parking events in the total number of parking events (total number of parking events including parking events other than forward parking events) in the first number of operating days. In that case, when the first frequency is higher than 50%, it may be diagnosed that the first user tends to park forward.

### Others

The above embodiment is merely illustrative, and the present disclosure may be appropriately modified and implemented without departing from the scope thereof. The processes and means described in the present disclosure can be freely combined and implemented as long as no technical contradiction occurs. Further, the processes described as being executed by one device may be shared and executed by a plurality of devices. For example, the first frequency may be calculated by the ECU 100. Alternatively, the processes described as being executed by different devices may be executed by one device. In the computer system, it is possible to flexibly change the hardware configuration for implementing each function.

What is claimed is:

1. An information processing device comprising a control unit configured to
acquire a first frequency, the first frequency being a frequency of forward parking events of a first vehicle per unit period, and
when the first frequency is equal to or greater than a first threshold, send first information on first equipment to a first terminal, the first equipment being equipment that is configured to assist in a driving operation related to reversing and that is mountable on the first vehicle.

2. The information processing device according to claim 1, wherein the control unit is configured to acquire, as the first frequency, a frequency of forward parking events of the first vehicle per operating day.

3. The information processing device according to claim 1, wherein the first equipment is equipment configured to detect a moving object approaching from right or left and give an alert when the first vehicle is reversing.
